(19) United States
(12) Patent Application Publication
(10) Pub. No.: US 2006/0271972 A1
(43) Pub. Date: Nov. 30, 2006

(54) Popularity-based on-demand media distribution

(75) Inventors: Akash L. Pai, Sunnyvale, CA (US); Yogananda Rao, Mountain View, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/141,417

(22) Filed: May 31, 2005

(51) Int. Cl. G06F 13/00; G06F 3/00; H04N 7/173; H04N 5/445

(52) U.S. Cl. 725/86; 725/87; 725/61

(57) ABSTRACT

Popularity-based on-demand media distribution is described. An on-demand media system includes multiple media sources, each configured to serve on-demand media content to one or more clients. On-demand media content is distributed among the media sources based on popularity of the media content such that at least one of the media sources is configured to serve more popular media content and at least another of the media sources is configured to serve less popular media content.

### TECHNICAL FIELD

This invention relates to on-demand media content, and more specifically to distribution of on-demand media content.

### BACKGROUND

On-demand media systems allow users to request available media content (e.g., movies, television programs, music, images, etc.) from a media server, which then transmits the requested media content to the user. A current typical media server may store approximately 200 titles, which are available to approximately 2000 users. However, with the increased popularity of on-demand media systems, it is expected that future systems may be implemented to support tens of thousands of titles, which will be made available to millions of users. Media content is typically very expensive to store. For example, one hour of video typically requires approximately 1.3 gigabytes of storage. With current systems, as additional titles are made available to users, a linear increase in storage cost is experienced. Accordingly, a need exists for techniques to enable economically feasible scalability of an on-demand media system to support increasing numbers of available titles and viewers.

### SUMMARY

Popularity-based on-demand media distribution is described. Media content is distributed among multiple on-demand media sources, each source being configured to serve the media content to one or more clients. The media content is distributed based on popularity such that more popular media content is served from one on-demand media source and less popular media content is served from another on-demand media source. Over time, the popularity of media content may be recalculated, and the media content may be redistributed accordingly among the multiple on-demand media sources. Popularity may be initially based on a release date associated with the media content, and may be subsequently based on a number of received on-demand requests for the media content. An on-demand media source may be implemented in any number of ways, including, but not limited to, as a server, a cluster of servers, one or more hard disks associated with one or more servers, or random access memory (RAM) associated with one or more servers.

### BRIEF DESCRIPTION OF THE DRAWINGS

FIG. 1 is a block diagram that illustrates an exemplary network environment in which popularity-based on-demand media distribution may be implemented.

FIG. 2 is a pictorial diagram that illustrates an exemplary network environment in which a three-level on-demand media system is implemented to support popularity-based on-demand media distribution.

FIG. 3 is a chart that illustrates an exemplary distribution of media content within a three level on-demand media system.

FIG. 4 is a block diagram that illustrates select components of an exemplary on-demand media server.

FIG. 5 is a flow diagram that illustrates an exemplary method for initial distribution of media content within a popularity-based on-demand media system.

FIG. 6 is a flow diagram that illustrates an exemplary method for dynamic redistribution of media content within a popularity-based on-demand media system.

FIG. 7 is a flow diagram that illustrates an exemplary method for dynamic redistribution of media content within a popularity-based on-demand media system.

FIG. 8 is a flow diagram that illustrates an exemplary method for redistributing media content from one on-demand media source to another on-demand media source.

FIG. 9 is a pictorial diagram of exemplary computing systems, devices, and components in an environment in which popularity-based on-demand media distribution may be implemented.

### DETAILED DESCRIPTION

The embodiments of popularity-based on-demand media distribution described below provide techniques for distributing on-demand media content within an on-demand media system based on popularity of the media content. An on-demand media system is implemented to include multiple media sources, with each source being configured to maintain and provide access to media content within a particular popularity range. For example, more popular media content may be maintained by a media source (e.g., a server or server cluster) located physically closer to client devices from which the media content may be requested. The media source may also be configured to maintain multiple copies of the media content to better support many concurrent requests for the media content. Less popular media content may be maintained by a media source located physically further away from the client devices, and may be maintained with less replication. Available media content is dynamically distributed among the multiple media sources based on popularity of the media content, determined, for example, by monitoring a number of received requests for the media content over time.

The following discussion is directed to popularity-based on-demand media distribution. While features of popularity-based on-demand media distribution can be implemented in any number of different computing environments, they are described in the context of the following exemplary implementations.

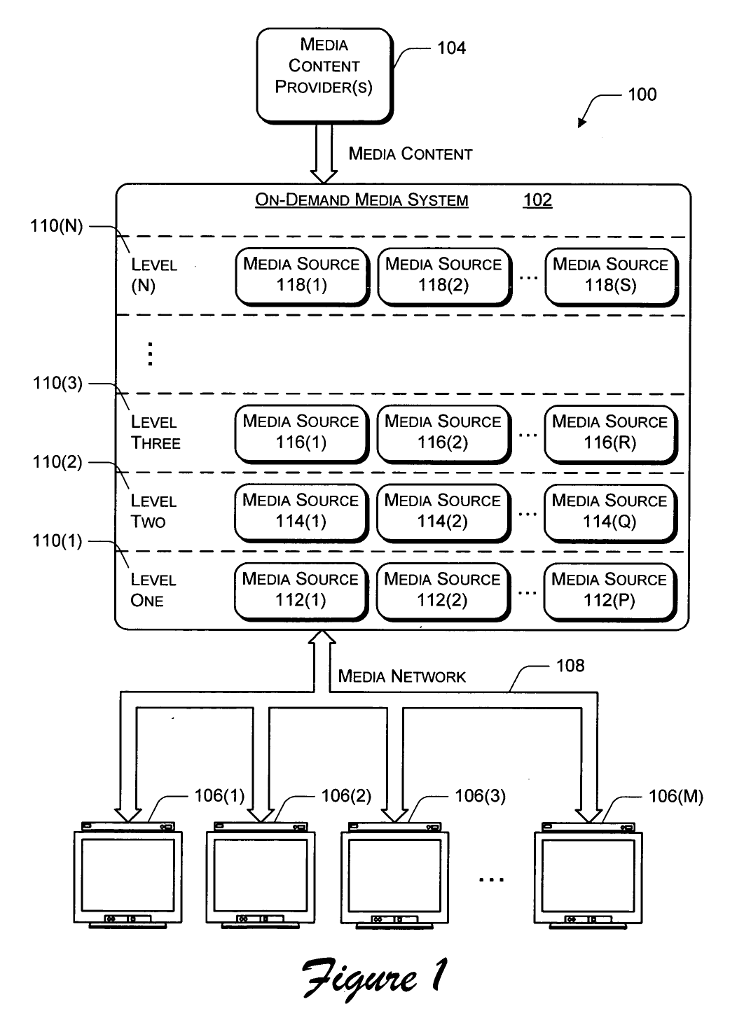

FIG. 1 illustrates an exemplary network environment 100 in which popularity-based on-demand media distribution may be implemented. On-demand media system 102 receives media content from one or more media content providers 104. On-demand media system 102 stores the received media content, and makes the media content available on-demand to client devices 106(1-M) over media network 108. Client devices 106(1-M) may be implemented in any number of ways, including, but not limited to, as a television set-top box, as a television with an integrated set-top box, as a personal computer, and so on.

On-demand media system 102 includes multiple levels, such as level one 110(1), level two 110(2), level three 110(3), . . . , and level N110(N). Media sources via which on-demand media content may be served are arranged among levels 110 such that more popular media content may be served from media sources associated with one level while less popular media content may be served from media sources associated with another level. For example, on-demand media system 102 includes media sources 112(1-P), associated with level one 110(1); media sources 114(1-Q), associated with level two 110(2); media sources 116(1-R), associated with level three 110(3); and media sources 118(1-S), associated with level (N) 110(N).

In an exemplary implementation, physical location and/or media source configuration may differ within and/or between levels. For example, media sources 112, associated with level one 110(1) may be configured to serve more popular media content, and thus may be located physically closer to client devices 106 (e.g., in a server cluster that located in and providing service to a particular geographic region), and/or may be implemented as random access memory (RAM) or another type of storage that enables quick access to media content stored therein. In contrast, media sources 116, associated with level three 110(3) may be configured to serve less popular media content, and thus may be located physically further from client devices 106 (e.g., in a headend server system remotely located to serve a large geographic region), and/or may be implemented as one or more hard disks or another type of storage from which retrieving media content may take more time.

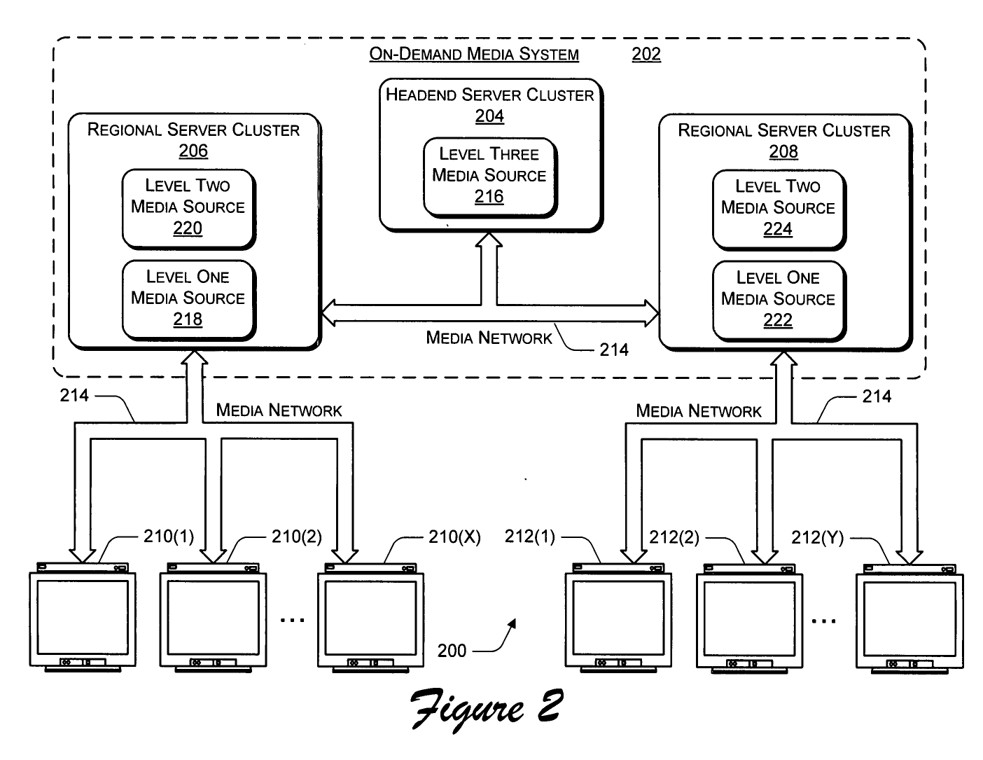

FIG. 2 illustrates an exemplary network environment 200 in which a three-level on-demand media system 202 is implemented to support popularity-based on-demand media distribution. On-demand media system 202 includes headend server cluster 204, regional server cluster 206, and regional server cluster 208. Client devices 210(1-X) and 212(1-Y) are each configured to request and receive media content from on-demand media system 202 over media network 214. In the illustrated example, headend server cluster 204 includes level three media source 216; regional server cluster 206 includes level one media source 218 and level two media source 220; and regional server cluster 208 includes level one media source 222 and level two media source 224.

Regional server cluster 206 is configured to serve client devices 210(1-X), for example, within one geographic region, and regional server cluster 208 is configured to serve client devices 212(1-Y), for example, within another geographic region. Headend server cluster 204 is configured to serve any one or more of the client devices 210(1-X) and 212(1-Y) within both geographic regions.

In the illustrated example, level three media source 216 is configured to maintain and serve the least popular media content; level two media sources 220 and 224 are configured to maintain and serve more popular media content; and level one media sources 218 and 222 are configured to maintain and serve the most popular media content. As an example, level three media source 216 may be implemented as one or more hard disks configured to store a large number of the least popular on-demand media content with little or no replication of titles. Level two media sources 220 and 224 may be implemented as one or more hard disks configured to store a smaller number of more popular on-demand media content, possibly with some replication. Level one media sources 218 and 222 may be implemented as one or more hard disks configured to store a small number of the most popular media content, typically with the most replication, thereby enabling a greater likelihood of timely access to the most popular media content by client devices 210-212. In an alternate implementation, level one media sources 218 and 222 may be implemented as random access memory (RAM), to provide quicker access to the media content than may be provided using hard disk storage. Although described as implementing hard disk storage, any other storage media may be implemented by any combination of media sources, or portions thereof, associated with any combination of levels, to maintain and serve available media content.

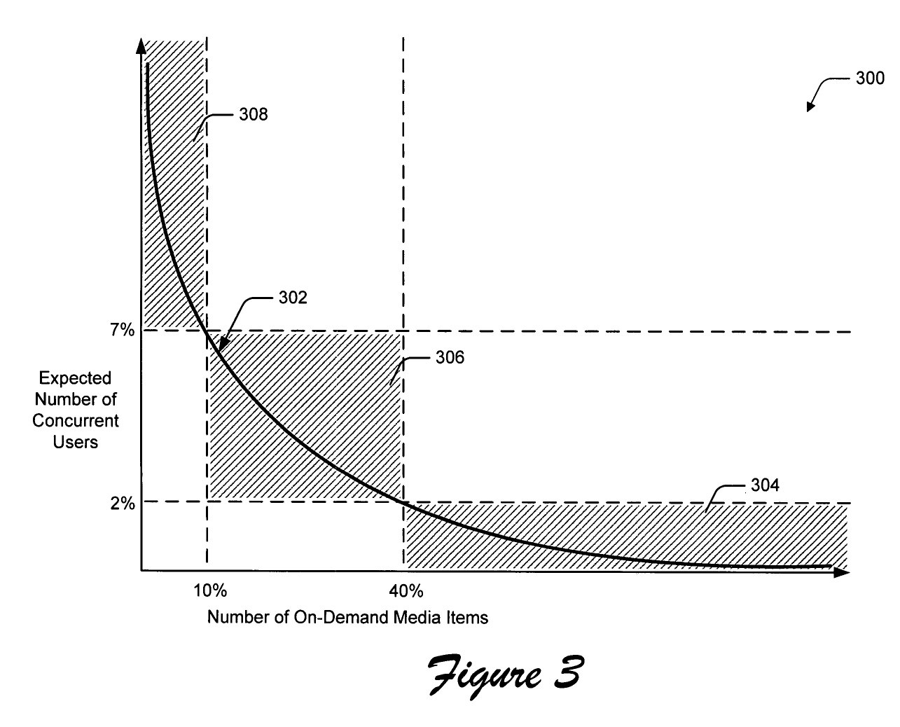

FIG. 3 illustrates an example distribution 300 of media content based on popularity. Curve 302 represents a number of individual on-demand media items along a horizontal axis of the example distribution 300. Each of the individual media items has an expected (or historically determined) number of concurrent users, which is represented along the vertical axis of the example distribution 300. The number of concurrent users may be interpreted to represent a media item's popularity. Shaded area 304 represents the largest number of media items (e.g., 60% of the total available media content), which have the fewest number of concurrent users (e.g., 2% or less). Accordingly, shaded area 304 represents the least popular media content. Referring to FIG. 2, the media content represented by shaded area 304 may be maintained and served from level three media source 216.

Shaded area 306 represents a smaller number of media items (e.g., 30% of the total available media content), which have more concurrent users (e.g., 2%-7%). Accordingly, shaded area 306 represents media content that is more popular than the media content represented by shaded area 304. Referring to FIG. 2, the media content represented by shaded area 306 may be maintained and served from level two media sources 220 and 224.

Shaded area 308 represents the smallest number of media items (e.g., 10% of the total available media content), which have the most concurrent users (e.g., more than 7%). Accordingly, shaded area 308 represents the most popular media content. Referring to FIG. 2, the media content represented by shaded area 308 may be maintained and served from level one media sources 218 and 222.

Although FIGS. 2 and 3 illustrate an exemplary on-demand media system implementation with three levels, it is recognized that the techniques described herein may be used to implement a VOD system having any number of levels for distributing media content based on popularity.

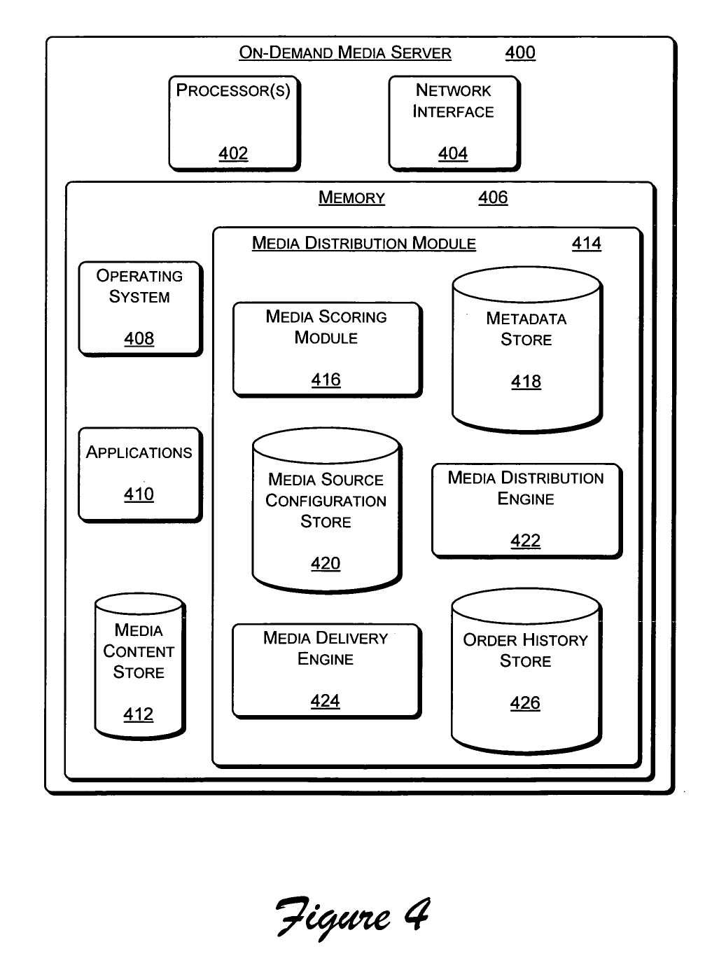

FIG. 4 illustrates selected components of an exemplary on-demand media server 400. Referring to FIG. 2, on-demand media server 400 may represent a server associated with headend server cluster 204, a server associated with one of regional server clusters 206 and 208, or any combination thereof. On-demand media server 400 includes one or more processors 402, a network interface 404, and memory component 406. Network interface 404 enables communication between on-demand media server 400 and other computer systems, such as client devices 210(1-X) and 212(1-Y) over media network 214. An operating system 408, one or more applications 410, media content store 412, and media distribution module 414 are stored in memory 406 and executed on processor 402. Media content store 412 maintains media content that may be requested by and served to one or more client devices.

Media distribution module 414 includes media scoring module 416, metadata store 418, media source configuration store 420, media distribution engine 422, media delivery engine 424, and order history store 426. Media scoring module 416 determines popularity scores associated with media content store in media content store 412. A popularity score may initially be assigned to a particular media item manually, for example, by a system administrator associated with on-demand media server 400, or dynamically based, for example, on the release date. The popularity score may be updated periodically based, for example, on a number of times that the particular media item has been ordered by users.

Metadata store 418 maintains metadata associated with media content stored in media content store 412. Metadata maintained by metadata store 418 may include, for example, a title, a release date, a popularity score, and a replication value. The replication value may indicate a number of times that the particular media item is to be replicated. The replication value may be based, for example, on a popularity score associated with the media item, with more popular media items having higher replication values than less popular media items.

Media source configuration store 420 maintains data that defines the configuration of various levels of media sources. For example, media source configuration store 420 may specify a number of levels supported by on-demand media system 202. Media source configuration store 420 may further specify for each supported level, additional parameters, such as a maximum number of titles to be maintained by a particular level, a minimum and/or maximum popularity score to be associated with a particular level, a degree of replication to be applied to a particular level, and so on.

Media distribution engine 422 manages the distribution of media content across multiple levels of media sources. For example, when a new media item is received, the media item may be initially distributed based on input from a system administrator or based on a metadata value associated with the media item such as a popularity score, which may be based on a release date. For example, a media item that is received that has a recent release date (e.g. within the last 30 days) may be distributed to a level one media source. If the received media item has a much older release date (e.g., an older movie with a release date five or more years ago), media distribution engine 422 may place the media item in a level three media source. Media distribution engine 422 is further configured to dynamically re-distribute media content across the supported levels of media sources based on updated popularity values associated with the media content.

Media delivery engine 424 is configured to manage delivery of media content to client devices based on received requests for the media content. Order history store 426 maintains data generated by media delivery engine 424 that describes which media content has been ordered by which users at what times. The data maintained by order history store 426 may further be used by media distribution engine 422 to update popularity values associated with the media content, which may then be used to redistribute the media content across multiple levels of media sources.

Methods for popularity-based on-demand media distribution may be described in the general context of computer executable instructions. Generally, computer executable instructions include routines, programs, objects, components, data structures, procedures, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

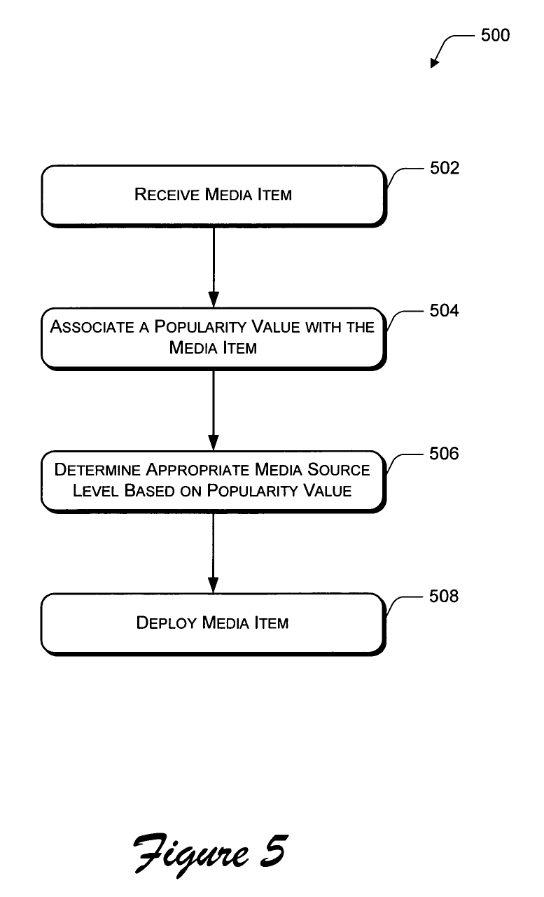

FIGS. 5-8 illustrate exemplary methods for implementing popularity-based on-demand media distribution. FIGS. 5-8 are specific examples of popularity-based on-demand media distribution, and are not to be construed as limitations. Furthermore, it is recognized that various embodiments may implement any combination of the methods illustrated in FIGS. 5-8 or any combination of portions of the methods illustrated in FIGS. 5-8.

FIG. 5 illustrates an exemplary method 500 for initial distribution of a particular media item based on popularity. The order in which the method is described is not intended to be construed as a limitation, and any number of the described method blocks can be combined in any order to implement the method. Furthermore, the method can be implemented in any suitable hardware, software, firmware, or combination thereof.

At block 502, a media item is received. For example, referring to FIG. 1, on-demand media system 102 receives a media item (e.g., a movie) from media content provider 104.

At block 504, a popularity value is associated with the received media item. For example, referring to FIG. 4, media scoring module 416 may determine a popularity value based on a release date associated with the received media item, and store the popularity value in metadata store 418.

At block 506, an appropriate media source level is determined based on the popularity value. For example, media distribution engine 422 may use the popularity value associated with the received media item to determine whether the media item should be maintained and served by a media source associated with level one 110(1), level two 110(2), level three 110(3), . . . , or level (N) 110(N).

At block 508, the media item is deployed. For example, if it is determined that the media item is to be maintained and served by level three media source 216, the media item is written to a hard disk associated with level three media source 216. On the other hand, if it is determined that the media item is to be maintained and served by a level one media source, then the media item is copied into RAM associated with level one media source 218 and level one media source 222. Furthermore, the media item may be replicated any number of times within the media source(s) depending, for example, on parameters associated with the media source, the media source level, and/or based on a popularity score associated with the media item.

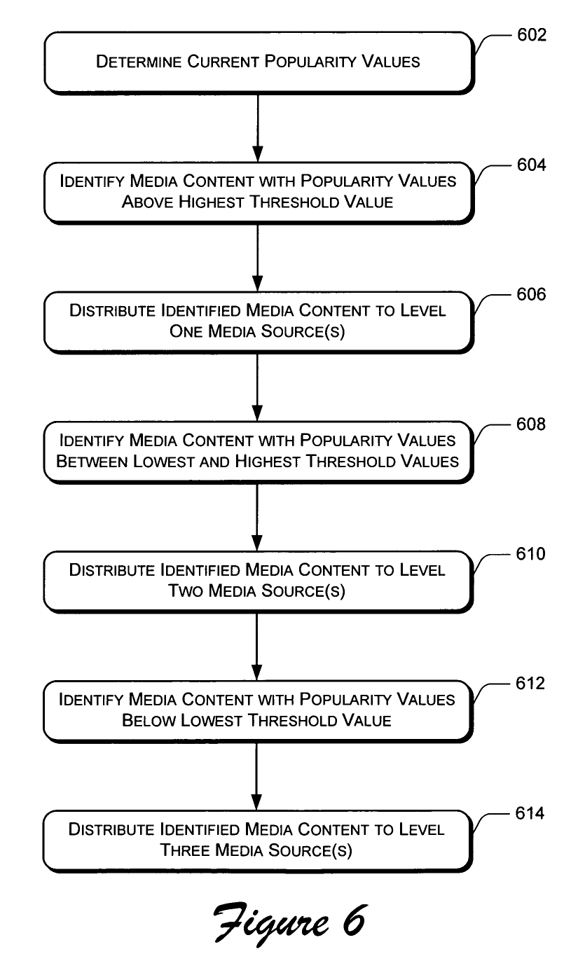

FIG. 6 illustrates an exemplary method 600 for dynamic redistribution of media content based on popularity. The order in which the method is described is not intended to be construed as a limitation, and any number of the described method blocks can be combined in any order to implement the method. Furthermore, the method can be implemented in any suitable hardware, software, firmware, or combination thereof.

At block 602 current popularity values associated with currently maintained media content are determined. For example, a server may re-calculate a popularity value for a particular media item based on a number of times that the media item has been requested within a particular time period. For example, a media item that has been requested more often (or by more users concurrently) may be assigned a higher popularity value than a media item that has been requested less often (or by fewer concurrent users).

At block 604, available media content with popularity values above a highest popularity threshold are identified. For example, if assigned popularity values are between one and ten, media items with popularity values of six or greater are identified.

At block 606, the identified media content is distributed to one or more level one media sources. For example, referring to FIG. 2, one or more copies of each media item with a popularity value of six or greater is distributed to each of level one media sources 218 and 222.

At block 608, media content with popularity values between the highest popularity threshold and a lowest popularity threshold is identified. For example, if assigned popularity values are between one and ten, media items with popularity values between two and five are identified.

At block 610, the identified media content is distributed to one or more level two media sources. For example, referring to FIG. 2, one or more copies of each media item with a popularity value between two and five are distributed to each of level two media sources 220 and 224.

At block 612, media content with popularity values below the lowest popularity threshold is identified. For example, if assigned popularity values are between one and ten, media items with popularity values equal to one are identified.

At block 614, the identified media content is distributed to one or more level three media sources. For example, referring to FIG. 2, one or more copies of each media item with a popularity value of one is distributed to level three media source 216.

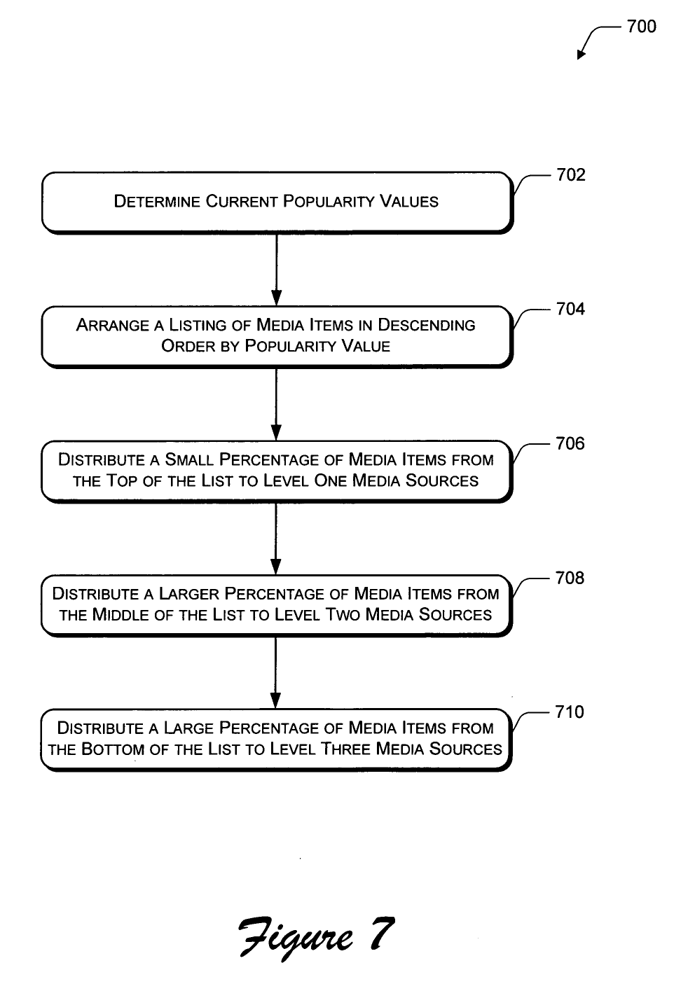

FIG. 7 illustrates an exemplary method 700 for dynamic redistribution of media content based on popularity. The order in which the method is described is not intended to be construed as a limitation, and any number of the described method blocks can be combined in any order to implement the method. Furthermore, the method can be implemented in any suitable hardware, software, firmware, or combination thereof.

At block 702 current popularity values associated with currently maintained media content are determined. For example, a server may re-calculate a popularity value for a particular media item based on a number of times that the media item has been requested within a particular time period. For example, a media item that has been requested more often (or by more users concurrently) may be assigned a higher popularity value than a media item that has been requested less often (or by fewer concurrent users).

At block 704, a listing of currently maintained media items is arranged in descending order by popularity values. For example, referring to FIG. 4, media distribution engine 422 queries metadata store 418 for a list of media items ordered by popularity value.

At block 706, a small percentage of the media items is selected from the top of the list and distributed to level one media sources. For example, referring to FIGS. 2 and 3, one or more copies of each of the top 10% of the media items (represented by shaded block 308 in FIG. 3) are distributed to each of level one media sources 218 and 222.

At block 708, a larger percentage of the media items is selected from the middle of the list and distributed to level two media sources. For example, referring to FIGS. 2 and 3, one or more copies of each of the next 30% of the media items (represented by shaded block 306 in FIG. 3) are distributed to each of level two media sources 220 and 224.

At block 710, a large percentage of the media items is selected from the bottom of the list and distributed to level three media sources. For example, referring to FIGS. 2 and 3, the remaining 60% of the media items (represented by block 304 in FIG. 3) are distributed to level three media source 216.

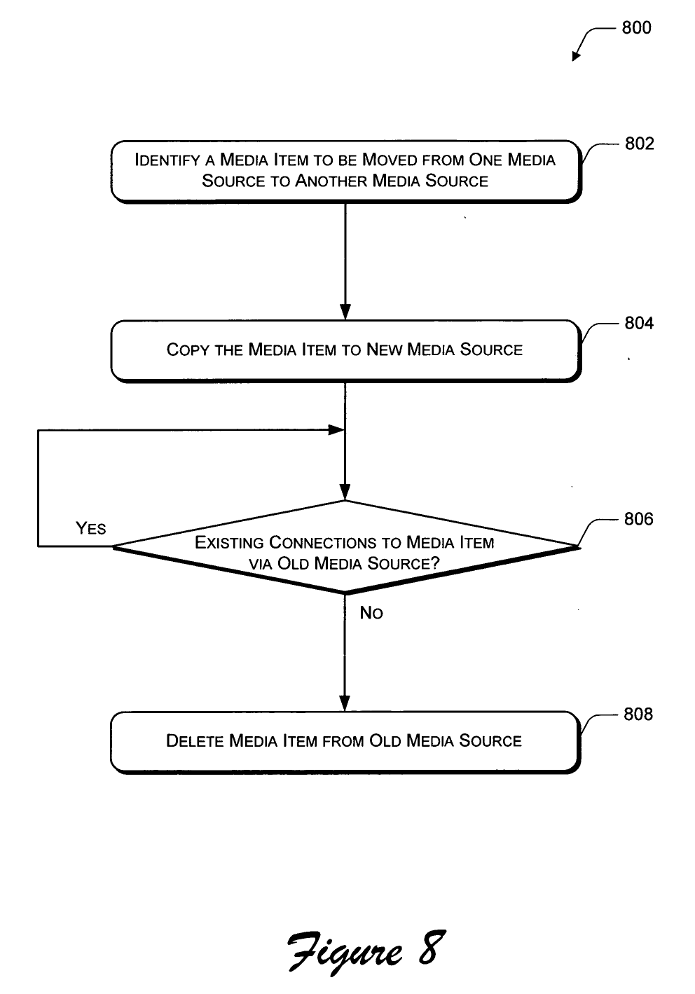

FIG. 8 illustrates an exemplary method 800 for redistributing media content from one media source to another media source. The order in which the method is described is not intended to be construed as a limitation, and any number of the described method blocks can be combined in any order to implement the method. Furthermore, the method can be implemented in any suitable hardware, software, firmware, or combination thereof.

At block 802 a media item to be moved from one media source to another media source is identified. For example, as described with reference to FIGS. 6 and 7, a server may, based on popularity, dynamically redistribute media content among multiple levels of media sources.

At block 804, the media item is copied to the new media source to which the media item is being distributed. For example, if a media item currently maintained in a level one media source is to be redistributed to a level two media source, then the media item is copied from the level one media source to the level two media source. After the media item is successfully copied to the new media source, any requests received for the media item are directed to the copy of the media item maintained by the new media source.

At block 806, it is determined whether or not there are any existing connections to the media item maintained by the old media source. This check is repeated, as indicated by the “Yes” branch from block 806 until no connections to the media item maintained by the old media source exist (as indicated by the “No” branch) from block 806. At block 808, the media item is deleted (or otherwise removed) from the old media source.

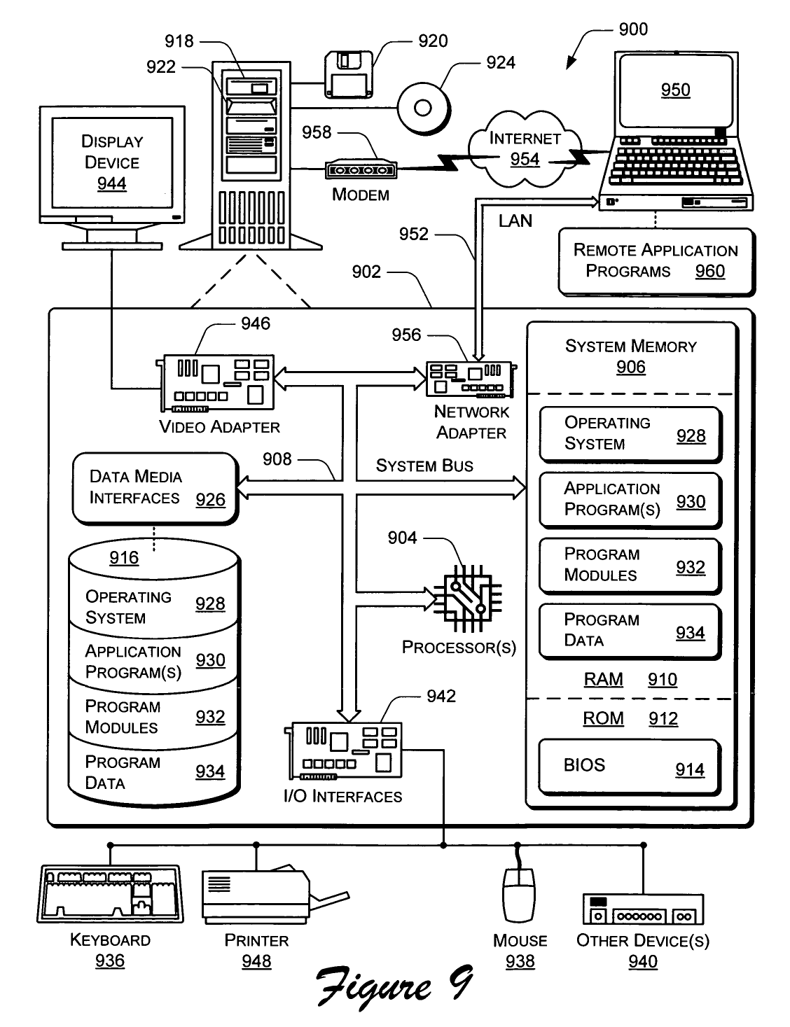

FIG. 9 illustrates an exemplary computing environment 900 within which popularity-based on-demand media distribution systems and methods, as well as the computing, network, and system architectures described herein, can be either fully or partially implemented. Exemplary computing environment 900 is only one example of a computing system and is not intended to suggest any limitation as to the scope of use or functionality of the architectures. Neither should the computing environment 900 be interpreted as having any dependency or requirement relating to any one or combination of components illustrated in the exemplary computing environment 900.

The computer and network architectures in computing environment 900 can be implemented with numerous other general purpose or special purpose computing system environments or configurations. Examples of well known computing systems, environments, and/or configurations that may be suitable for use include, but are not limited to, personal computers, server computers, client devices, hand-held or laptop devices, microprocessor-based systems, multiprocessor systems, set top boxes, programmable consumer electronics, network PCs, minicomputers, mainframe computers, gaming consoles, distributed computing environments that include any of the above systems or devices, and the like.

The computing environment 900 includes a general-purpose computing system in the form of a computing device 902. The components of computing device 902 can include, but are not limited to, one or more processors 904 (e.g., any of microprocessors, controllers, and the like), a system memory 906, and a system bus 908 that couples the various system components. The one or more processors 904 process various computer executable instructions to control the operation of computing device 902 and to communicate with other electronic and computing devices. The system bus 908 represents any number of several types of bus structures, including a memory bus or memory controller, a peripheral bus, an accelerated graphics port, and a processor or local bus using any of a variety of bus architectures.

Computing environment 900 includes a variety of computer readable media which can be any media that is accessible by computing device 902 and includes both volatile and non-volatile media, removable and non-removable media. The system memory 906 includes computer readable media in the form of volatile memory, such as random access memory (RAM) 910, and/or non-volatile memory, such as read only memory (ROM) 912. A basic input/output system (BIOS) 914 maintains the basic routines that facilitate information transfer between components within computing device 902, such as during start-up, and is stored in ROM 912. RAM 910 typically contains data and/or program modules that are immediately accessible to and/or presently operated on by one or more of the processors 904.

Computing device 902 may include other removable/non-removable, volatile/non-volatile computer storage media. By way of example, a hard disk drive 916 reads from and writes to a non-removable, non-volatile magnetic media (not shown), a magnetic disk drive 918 reads from and writes to a removable, non-volatile magnetic disk 920 (e.g., a “floppy disk”), and an optical disk drive 922 reads from and/or writes to a removable, non-volatile optical disk 924 such as a CD-ROM, digital versatile disk (DVD), or any other type of optical media. In this example, the hard disk drive 916, magnetic disk drive 918, and optical disk drive 922 are each connected to the system bus 908 by one or more data media interfaces 926. The disk drives and associated computer readable media provide non-volatile storage of computer readable instructions, data structures, program modules, and other data for computing device 902.

Any number of program modules can be stored on RAM 910, ROM 912, hard disk 916, magnetic disk 920, and/or optical disk 924, including by way of example, an operating system 928, one or more application programs 930, other program modules 932, and program data 934. Each of such operating system 928, application program(s) 930, other program modules 932, program data 934, or any combination thereof, may include one or more embodiments of the popularity-based on-demand media distribution systems and methods described herein.

Computing device 902 can include a variety of computer readable media identified as communication media. Communication media typically embodies computer readable instructions, data structures, program modules, or other data in a modulated data signal such as a carrier wave or other transport mechanism and includes any information delivery media. The term “modulated data signal” refers to a signal that has one or more of its characteristics set or changed in such a manner as to encode information in the signal. By way of example and not limitation, communication media includes wired media such as a wired network or direct-wired connection, and wireless media such as acoustic, RF, infrared, other wireless media, and/or any combination thereof.

A user can interface with computing device 902 via any number of different input devices such as a keyboard 936 and pointing device 938 (e.g., a “mouse”). Other input devices 940 (not shown specifically) may include a microphone, joystick, game pad, controller, satellite dish, serial port, scanner, and/or the like. These and other input devices are connected to the processors 904 via input/output interfaces 942 that are coupled to the system bus 908, but may be connected by other interface and bus structures, such as a parallel port, game port, and/or a universal serial bus (USB).

A display device 944 (or other type of monitor) can be connected to the system bus 908 via an interface, such as a video adapter 946. In addition to the display device 944, other output peripheral devices can include components such as speakers (not shown) and a printer 948 which can be connected to computing device 902 via the input/output interfaces 942.

Computing device 902 can operate in a networked environment using logical connections to one or more remote computers, such as remote computing device 950. By way of example, remote computing device 950 can be a personal computer, portable computer, a server, a router, a network computer, a peer device or other common network node, and the like. The remote computing device 950 is illustrated as a portable computer that can include any number and combination of the different components, elements, and features described herein relative to computing device 902.

Logical connections between computing device 902 and the remote computing device 950 are depicted as a local area network (LAN) 952 and a general wide area network (WAN) 954. Such networking environments are commonplace in offices, enterprise-wide computer networks, intranets, and the Internet. When implemented in a LAN networking environment, the computing device 902 is connected to a local network 952 via a network interface or adapter 956. When implemented in a WAN networking environment, the computing device 902 typically includes a modem 958 or other means for establishing communications over the wide area network 954. The modem 958 can be internal or external to computing device 902, and can be connected to the system bus 908 via the input/output interfaces 942 or other appropriate mechanisms. The illustrated network connections are merely exemplary and other means of establishing communication link(s) between the computing devices 902 and 950 can be utilized.

In a networked environment, such as that illustrated with computing environment 900, program modules depicted relative to the computing device 902, or portions thereof, may be stored in a remote memory storage device. By way of example, remote application programs 960 are maintained with a memory device of remote computing device 950. For purposes of illustration, application programs and other executable program components, such as operating system 928, are illustrated herein as discrete blocks, although it is recognized that such programs and components reside at various times in different storage components of the computing device 902, and are executed by the one or more processors 904 of the computing device 902.

Although embodiments of popularity-based on-demand media distribution have been described in language specific to structural features and/or methods, it is to be understood that the subject of the appended claims is not necessarily limited to the specific features or methods described. Rather, the specific features and methods are disclosed as exemplary implementations of popularity-based on-demand media distribution.

1. A method comprising:
receiving a plurality of media items to be made available on-demand; and
distributing the media items among one or more media sources based on popularity scores associated with the media items, the media sources configured to serve the media items on demand.

2. The method as recited in claim 1, wherein the popularity scores are based on release dates associated with the media items.

3. The method as recited in claim 1, wherein distributing the media items comprises:
determining a popularity score associated with a particular one of the media items;
identifying one or more media sources having an associated popularity score range that includes the popularity score associated with the particular one of the media items; and
transmitting the particular one of the media items to the identified one or more media sources having the associated popularity score range that includes the popularity score associated with the particular one of the media items.

4. The method as recited in claim 3, wherein distributing the media items further comprises replicating the particular one of the media items within the one or more media sources.

5. The method as recited in claim 4, further comprising determining a number of times to replicate the particular one of the media items based on the popularity score associated with the particular one of the media items.

6. The method as recited in claim 1, wherein the media items comprise at least one of video data, audio data, music, a photo, a still image, a television program, or a movie.

7. The method as recited in claim 1, wherein the one or more media sources comprise at least one of a server, a server cluster, a hard disk, or random access memory.

8. The method as recited in claim 1, further comprising:
recalculating the popularity scores associated with the media items; and
redistributing the media items among the one or more media sources based on the recalculated popularity scores.

9. The method as recited in claim 8, wherein the recalculating comprises determining a number of times that a particular one of the media items has been requested during a particular time period.

10. A system comprising:
a first media source for maintaining and serving more popular media content; and
a second media source for maintaining and serving less popular media content.

11. The system as recited in claim 10, wherein the first media source is configured as multiple server systems, each configured to serve on-demand media content to clients within a particular geographic region.

12. The system as recited in claim 10, wherein the first media source is implemented as at least one of a hard disk associated with a server computer system, or a random access memory (RAM) component of a server computer system.

13. The system as recited in claim 10, further comprising a scoring module configured to determine popularity scores associated with the media content.

14. The system as recited in claim 10, further comprising a media distribution engine configured to distribute the media content among the first and second media sources based on popularity of the media content.

15. The system as recited in claim 10, further comprising a media request history store configured to count a number of received requests for media content such that the number of received requests may be used to recalculate popularity scores associated with the media content.

16. One or more computer-readable media comprising computer-readable instructions which, when executed, cause a computer system to:
distribute a first media item to a first media source that is configured to serve more popular media content to requesting clients; and
distribute a second media item to a second media source that is configured to serve less popular media content to the requesting clients.

17. The one or more computer-readable media as recited in claim 16, further comprising computer-readable instructions which, when executed, cause the computer system to replicate the first media item within the first media source.

18. The one or more computer-readable media as recited in claim 16, further comprising computer-readable instructions which, when executed, cause the computer system to:
receive a client request for the first media item; and
establish a connection between the client and the first media item via the first media source.

19. The one or more computer-readable media as recited in claim 16, further comprising computer-readable instructions which, when executed, cause the computer system to:
determine that the second media item is more popular than the first media item; and
redistribute the second media item from the second media source to the first media source.

20. The one or more computer-readable media as recited in claim 19, further comprising computer-readable instructions which, when executed, cause the computer system to redistribute the second media item from the second media source to the first media source by:
copying the second media item to the first media source;
identifying existing connections to the second media item via the second media source; and
upon termination of the existing connections to the second media item via the second media source, deleting the second media item from the second media source.
